(19) United States
(12) Patent Application Publication
(10) Pub. No.: US 2026/0251900 A1
(43) Pub. Date: Aug. 27, 2026

(54) OPTICAL MODULE AND HEAD-MOUNTED DISPLAY DEVICE

(71) Applicant: Goertek Optical Technology Co., Ltd, Weifang, Shandong (CN)

(72) Inventor: Chaiyuan Shi, Shandong (CN)

(73) Assignee: Goertek Optical Technology Co., Ltd., Weifang, Shandong (CN)

(21) Appl. No.: 18/870,754

(22) PCT Filed: Jun. 27, 2022
(86) PCT No.: PCT/CN2022/101470

§ 371 Date: Dec. 2, 2024

(30) Foreign Application Priority Data
May 30, 2022 (CN) 202210602540.1

(51) Int. Cl. G02B 27/01; G02B 3/04; G02B 5/30; G02B 27/14; G02B 27/28

(52) U.S. Cl. CPC G02B 27/0172; G02B 3/04; G02B 5/3083; G02B 27/142; G02B 27/286; G02B 2027/011; G02B 2027/0154; G02B 2027/0194

(57) ABSTRACT

The disclosure provides an optical module and a head mounted display. The optical module includes a first lens and a second lens, the first lens including a first surface and a second surface, the second lens including a third surface and a fourth surface, the second surface being provided adjacent to the third surface; the optical module further includes a beam splitter, a first phase retarder, and a polarizing reflection element.

### CROSS-REFERENCE TO RELATED APPLICATIONS

The present disclosure is a National Stage of International Application No. PCT/CN2022/101470, filed on Jun. 27, 2022, which claims priority to a Chinese patent application No. 202210602540.1 filed with the CNIPA on May 30, 2022, both of which are hereby incorporated by reference in their entireties.

### TECHNICAL FIELD

Embodiments of the present disclosure relate to the technical field of near-eye display imaging, and particularly to an optical module and a head mounted display.

### BACKGROUND

In recent years, augmented reality (AR) and virtual reality (VR) technologies have been applied and rapidly developed in smart wearable devices, for example. Core components of both AR and VR technologies are optical modules.

Typically, in the design of an optical module, the distance between the human eye and the optical lens on the near-eye side of the optical module is fixed, i.e., the eye-to-lens distance is fixed. However, when different users are using the same optical module, the actual eye-to-lens distance varies. This is because users with normal diopters and those with myopia or hyperopia will have different eye-to-lens distances due to the need for diopter correction (wearing glasses or not wearing glasses), which may lead to different degrees of absence of images viewed by groups with different eye-to-lens distances during the virtual experience, preventing them from observing complete images.

### SUMMARY

An objective of the present disclosure is to provide new technical solutions for an optical module and a head mounted display.

In a first aspect, the present disclosure provides an optical module. The optical module includes a first lens and a second lens, the first lens including a first surface and a second surface, the second lens including a third surface and a fourth surface, the second surface being provided adjacent to the third surface;
the optical module further includes a beam splitter, a first phase retarder, and a polarizing reflection element, the beam splitter is located on one side of the first surface, and the first phase retarder and the polarizing reflection element are located on either side of the second lens; and
the first lens is configured to be translatable relative to the second lens, and satisfies: 0.05<2*(T1−T2)/D1<0.3, wherein T1 is a maximum distance from the second surface to the third surface, T2 is a minimum distance from the second surface to the third surface, and D1 is an optical effective aperture of the first lens.

Optionally, the first lens is configured to be translatable in a direction away from or close to the second lens, and satisfies: 0.1<2*(T1−T2)/D1<0.2.

Optionally, the first lens is translatable relative to the second lens by 4 mm to 5.5 mm.

Optionally, a distortion difference “a” between a hyperopia half-field angle of the optical module and a myopia half-field angle of the optical module is: 0°<a<10°.

Optionally, the first lens has a central thickness T₁: 3 mm<T₁<8 mm; the second lens has a central thickness T₂: 3 mm<T₂<8 mm.

Optionally, the first surface and the second surface are both aspherical; the third surface is flat or aspherical, and the fourth surface is aspherical.

Optionally, the first phase retarder and the polarizing reflection element are sequentially arranged between the second surface and the third surface.

Optionally, the optical module further includes a polarizing element, which is located between the polarizing reflection element and the third surface.

Optionally, the polarizing element, the polarizing reflection element, and the first phase retarder are stacked to form a laminated film structure and attached to the third surface, wherein the polarizing element is connected to the third surface.

Optionally, the beam splitter has a reflectivity of 47% to 53%.

Optionally, the optical module further includes a display, a light emergent surface of which is configured to emit circularly polarized light or linearly polarized light; when the light emergent surface of the display emits the linearly polarized light, a second phase retarder is provided between the light emergent surface of the display and the first surface of the first lens, and is used to convert the linearly polarized light into the circularly polarized light.

Optionally, the beam splitter is attached to the first surface; or, the beam splitter is located between the light emergent surface of the display and the first surface.

In a second aspect, the present disclosure provides a head-mounted display, which includes: a housing; and the above optical module.

According to the embodiment of the present disclosure, a folded optical path solution is provided. This enables diopter adjustment by changing the position of the first lens, located near the incident light, relative to the second lens in the optical module. Additionally, it ensures no absence of the imaging scenes during the diopter adjustment process without altering the fixed eye-to-lens distance by constraining the relationship between the maximum distance difference at which the first lens can move relative to the second lens and the effective optical aperture of the first lens itself. This allows the user to enjoy a better visual experience.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings incorporated in and constituting a part of the specification illustrate embodiments of present disclosure and together with the description thereof, serve to explain the principles of the disclosure.

FIG. 1 is a first schematic structural diagram of an optical module provided by an embodiment of the present disclosure;

FIG. 2 is a partial schematic structural diagram of the optical module provided by an embodiment of the present disclosure;

FIG. 3 is a schematic diagram of a point array of the optical module shown in FIG. 1;

FIG. 4 is an MTF graph of the optical module shown in FIG. 1;

FIG. 5 is a field curvature distortion diagram of the optical module shown in FIG. 1;

FIG. 6 is a lateral chromatic distortion diagram of the optical module shown in FIG. 1;

FIG. 7 is a second schematic structural diagram of an optical module provided by an embodiment of the present disclosure;

FIG. 8 is a schematic diagram of a point array of the optical module shown in FIG. 7;

FIG. 9 is an MTF graph of the optical module shown in FIG. 7;

FIG. 10 is a field curvature distortion diagram of the optical module shown in FIG. 7;

FIG. 11 is a lateral chromatic distortion diagram of the optical module shown in FIG. 7;

FIG. 12 is a third schematic structural diagram of an optical module provided by an embodiment of the present disclosure;

FIG. 13 is a schematic diagram of a point array of the optical module shown in FIG. 12;

FIG. 14 is an MTF graph of the optical module shown in FIG. 12;

FIG. 15 is a field curvature distortion diagram of the optical module shown in FIG. 12;

FIG. 16 is a lateral chromatic distortion diagram of the optical module shown in FIG. 12;

FIG. 17 is a fourth schematic structural diagram of an optical module provided by an embodiment of the present disclosure;

FIG. 18 is a schematic diagram of a point array of the optical module shown in FIG. 17;

FIG. 19 is an MTF graph of the optical module shown in FIG. 17;

FIG. 20 is a field curvature distortion diagram of the optical module shown in FIG. 17;

FIG. 21 is a lateral chromatic distortion diagram of the optical module shown in FIG. 17;

FIG. 22 is a fifth schematic structural diagram of an optical module provided by an embodiment of the present disclosure;

FIG. 23 is a schematic diagram of a point array of the optical module shown in FIG. 22;

FIG. 24 is an MTF graph of the optical module shown in FIG. 22;

FIG. 25 is a field curvature distortion diagram of the optical module shown in FIG. 22;

FIG. 26 is a lateral chromatic distortion diagram of the optical module shown in FIG. 22;

FIG. 27 is a sixth schematic structural diagram of an optical module provided by an embodiment of the present disclosure;

FIG. 28 is a schematic diagram of a point array of the optical module shown in FIG. 27;

FIG. 29 is an MTF graph of the optical module shown in FIG. 27;

FIG. 30 is a field curvature distortion diagram of the optical module shown in FIG. 27;

FIG. 31 is a lateral chromatic distortion diagram of the optical module shown in FIG. 27;

FIG. 32 is a seventh schematic structural diagram of an optical module provided by an embodiment of the present disclosure;

FIG. 33 is a schematic diagram of a point array of the optical module shown in FIG. 32;

FIG. 34 is an MTF graph of the optical module shown in FIG. 32;

FIG. 35 is a field curvature distortion diagram of the optical module shown in FIG. 32;

FIG. 36 is a lateral chromatic distortion diagram of the optical module shown in FIG. 32.

### DESCRIPTION OF REFERENCE SIGNS

10, first lens; 11, first surface; 12, second surface; 20, second lens; 21, third surface; 22, fourth surface; 30, anti-reflection film; 40, beam splitter; 50, phase retarder; 60, polarizing reflection element; 70, polarizing element; 80, display; 81, protective glass; 01, human eyes.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

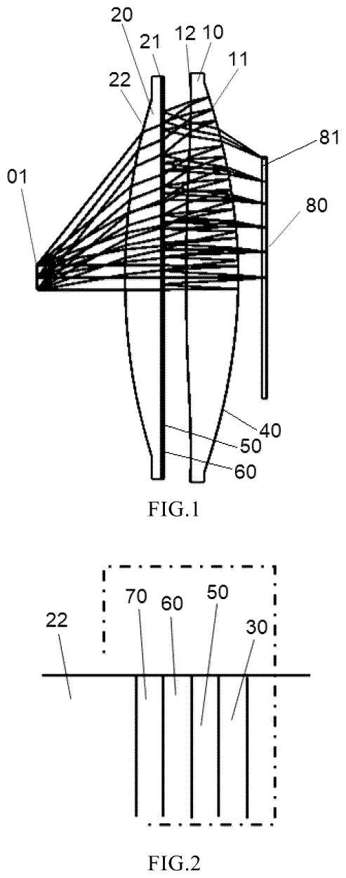

The optical module and the head mounted display provided by the embodiments of the present disclosure are described in detail below with reference to FIGS. 1 to 36.

According to an aspect of an embodiment of the present disclosure, an optical module is provided. The optical module is a folded optical path optical structure design, which may include two optical lenses and can be suitably applied to a head mounted display (HMD). For example, the VR headset may include VR glasses or a VR helmet, which is not specifically limited by embodiments of the present disclosure.

Embodiments of the present disclosure provide an optical module, as shown in FIGS. 1, 2, 7, 12, 17, 22, 27 and 32. The optical module includes a first lens 10 and a second lens 20, the first lens 10 including a first surface 11 and a second surface 12, the second lens 20 including a third surface 21 and a fourth surface 11, the second surface 12 being provided adjacent to the third surface 21;

the optical module further includes a beam splitter 40, a first phase retarder 50, and a polarizing reflection element 60, the beam splitter 40 is located on one side of the first surface 11, and the first phase retarder 50 and the polarizing reflection element 60 are located on either side of the second lens 20;

the first lens 10 is configured to be translatable relative to the second lens 20, and satisfies: 0.05<2*T1−T2/D1<0.3, wherein T1 is a maximum distance from the second surface 12 to the third surface 21, T2 is a minimum distance from the second surface 12 to the third surface 21, and D1 is an optical effective aperture of the first lens 10.

In the optical module provided by the embodiment of the present disclosure, the first lens 10 (provided proximate to the incident light) is not fixed, and is designed so that its position in the optical module can be adjusted to a certain extent relative to the second lens 20, while the position of the second lens 20 proximate to the human eye 01 is fixed.

According to the embodiment of the present disclosure, a folded optical path solution is provided. This enables diopter adjustment by changing the position of the first lens, located near the incident light, relative to the second lens in the optical module. Additionally, it ensures no absence of the imaging scenes during the diopter adjustment process without altering the fixed eye-to-lens distance by constraining the relationship between the maximum distance difference at which the first lens can move relative to the second lens and the effective optical aperture of the first lens itself. This allows the user to enjoy a better visual experience.

In the embodiments of the present disclosure, the first lens 10 and the second lens 20 may maintain a certain fixed interval, which may range from 2 mm to 4 mm. Refer to Tables 1 to 3 below for the parameters.

When it is necessary to adjust the first lens 10 in the optical module, the first lens 10 may be translated left or right relative to the second lens 20, such that the first lens 10 moves close to or away from the second lens 20, thereby allowing for diopter adjustment under the same eye-to-lens distance. Here, the diopter adjustment may be for myopia or hyperopia, such that the optical module of the embodiments of the present disclosure may be applied to people with different diopters, thereby providing complete imaging under the same eye-to-lens distance.

Furthermore, the method of moving the first lens 10, such as through a drive mechanism, may be flexibly designed by those skilled in the art, which is not limited by embodiments of the present disclosure.

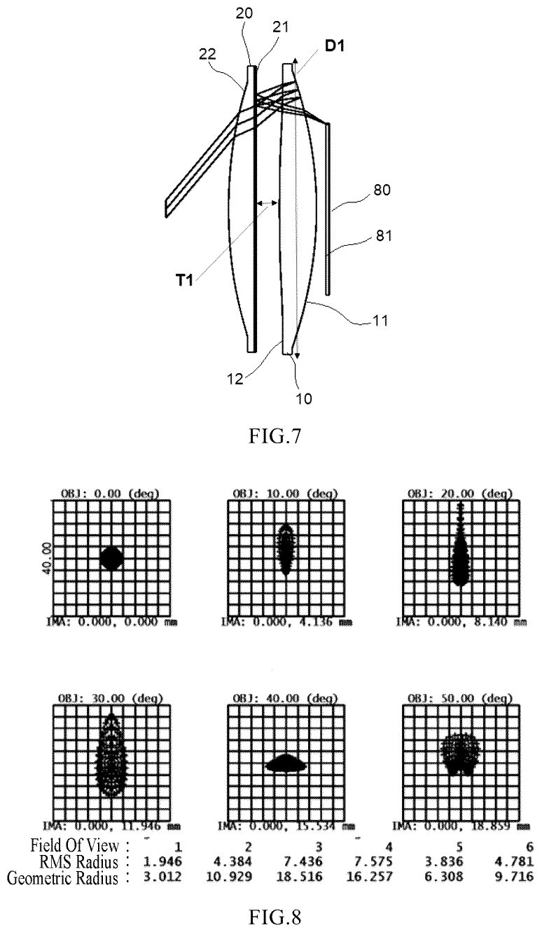

In the embodiments of the present disclosure, when moving the first lens 10, the following constraint condition must be satisfied: 0.05<2*(T1−T2)/D1<0.3. Here, as shown in FIG. 7, T1 is the limit position at which the first lens 10 is moved to the rightmost side of the second lens 20, and D1 is the effective optical aperture of the first lens 10. As shown in FIG. 8, T2 is the limit position at which the first lens 10 is moved to the leftmost position of the second lens 20. By satisfying this constraint condition, it is possible to ensure that under a fixed eye-to-lens distance, reasonable diopter adjustments may be made to ensure that there is no absence of a displayed imaging scenes observed by groups with different diopters.

According to the embodiments of the present disclosure, a folded optical path solution is provided. By appropriately moving the position of the first lens 10 relative to the second lens 20 in the optical path structure such that an appropriate distance is maintained between the first lens 10 and the second lens 20, it is possible to allow the optical module to realize no absence of the displayed imaging scenes in the diopter adjustment process without altering the fixed eye-to-lens distance.

The optical module provided by the embodiments of the present disclosure not only includes a lens group but also includes the above beam splitter 40, first phase retarder 50, and polarizing reflection element 60.

Here, the beam splitter 40 is a film structure, for example.

The beam splitter 40 may for example be located on one side of the first lens 10 where light is incident, i.e., proximate to the first surface 11 of the first lens 10. Of course, the beam splitter 40 may be directly attached to the first surface 11 of the first lens 10. Those skilled in the art may flexibly adjust the specific position of the beam splitter 40 as needed.

Here, the first phase retarder 50 may be used to change the polarization state of light in the folded optical path structure, and for example, it may convert the linearly polarized light to the circularly polarized light, or vice versa.

Here, the polarizing reflection element 60 may be used to allow P-polarized light to pass through and reflect S-polarized light, or to allow the S-polarized light to pass through and reflect the P-polarized light.

Cooperation of the first phase retarder 50 and the polarizing reflection element 60 may be used to analyze and transfer light.

For example, the first phase retarder 50 and the polarizing reflection element 60 may be film structures.

The first phase retarder 50 and the polarizing reflection element 60 may for example be provided on either side of the second lens 20. Of course, the first phase retarder 50 and the polarizing reflection element 60 may also be on either surface of the second lens 20. Those skilled in the art may flexibly adjust the specific positions of the first phase retarder 50 and the polarizing reflection element 60 as needed.

Additionally, the first phase retarder 50 and the polarizing reflection element 60 may be attached together or provided at intervals, which is not specifically limited by embodiments of the present disclosure.

The optical module provided by the embodiments of the present disclosure: the incident light is transmitted through the first lens 10, is reflected by the third surface 21 of the second lens 20, is transmitted through the second surface 12 of the first lens 10, and is reflected by the first surface 11. After transmission through the second surface 12 and the second lens 20, the light is incident into the human eye 01.

The optical module provided by the embodiments of the present disclosure is a folded optical path optical structure design, and as shown in FIGS. 1, 7, 12, 17, 22, 27, and 32, various optical lenses and optical components in the optical module may be arranged in a predetermined manner and located on the same optical axis. The entire optical path structure has a small size and does not occupy much space.

In some examples of the present disclosure, the first lens 10 is configured to be translatable in a direction away from or close to the second lens 20, and satisfies: 0.1<2*(T1−T2)/D1<0.2.

As shown in FIG. 7, T1 is the limit position at which the first lens 10 is moved to the rightmost side of the second lens 20, and D1 is the effective optical aperture of the first lens 10.

As shown in FIG. 8, T2 is the limit position at which the first lens 10 is moved to the leftmost position of the second lens 20.

By further optimizing the constraint conditions, it is possible to better ensure that under the same fixed eye-to-lens distance, the displayed imaging scenes observed by groups with different diopters will not be absent. It is also possible to make the distortion difference of the formed image smaller, resulting in imaging scenes with better texture and higher clarity.

For example, the first lens 10 is configured to be translatable in a direction away from or close to the second lens 20, and satisfies: 2*(T1−T2)/D1=0.15.

Alternatively, for example, the first lens 10 is configured to be translatable in a direction away from or close to the second lens 20, and satisfies: 2*(T1−T2)/D1=0.1.

Alternatively, for example, the first lens 10 is configured to be translatable in a direction away from or close to the second lens 20, and satisfies: 2*(T1−T2)/D1=0.2.

In some examples of the present disclosure, the first lens 10 can be translated by 4 mm-5.5 mm relative to the second lens 20.

That is to say, in the optical module provided by the embodiments of the present disclosure, the first lens 10 is designed so that it may be translated by a certain distance in a direction close to the second lens 20, and as shown in FIG. 8, the second lens 20 may approach the first lens 10. Also, the first lens 10 may also be translated in a direction away from the second lens 20, and as shown in FIG. 7, the first lens 10 at this point is far away from the second lens 20.

It should be noted that whether the first lens 10 is moved in a direction close to the second lens 20 or away from the second lens 20, the maximum movable range between them is the above 4 mm to 5.5 mm. Within this range, by adjusting the position of the first lens 10 relative to the second lens 20 in the optical path structure, it is possible to achieve the adjustment of different diopters at a fixed eye-to-lens distance.

In some examples of the present disclosure, a distortion difference “a” between a hyperopia half-field angle of the optical module and a near-field half-angle of the optical module is: 0°<a<10°.

In the embodiments of the present disclosure, through the constraint of the difference in field angle under different diopters, it is possible to control the distortion value under different diopters, ensuring that the same distortion pre-correction is suitable for different diopter situations.

In the embodiments of the present disclosure, the difference between the myopia and hyperopia half-field angles may be less than 10°, or even less than 5°.

That is to say, in the solution provided by the embodiments of the present disclosure, by constraining the distance over which the first lens 10 moves, the effective optical aperture D1 of the first lens 10 itself, and the field angle, it is possible to ensure that, under a fixed eye-to-lens distance, there is no absence of the displayed scenes during the diopter adjustment process without altering the fixed eye-to-lens distance.

In the embodiments of the present disclosure, there is no limitation on the diopter range for myopia and hyperopia.

In some examples of the present disclosure, the first lens 10 has a central thickness T₁: 3 mm<T₁<8 mm; the second lens 20 has a central thickness T₂: 3 mm<T₂<8 mm.

In some examples of the present disclosure, the first surface 11 and the second surface 12 are both aspherical; the third surface 21 is flat or aspherical, and the fourth surface 22 is aspherical.

Here, the first lens 10 and the second lens 20 have positive refractive power.

For example, the refractive power φ₁ of the first lens 10 satisfies: 0<φ₁<0.1.

For example, the refractive power φ₂ of the second lens 20 satisfies: 0<φ₂<0.01.

In the embodiments of the present disclosure, the first lens 10 is designed to be located on one side of the entire optical module where light is incident. The incident light may pass through the first lens 10, and is incident into the second lens 20 after being reflected at different surfaces of the first lens 10.

Optionally, an anti-reflection film may be provided on the second surface 12 or one side of the first lens 10. Thus, a beam splitter 40 and an anti-reflection film are respectively provided on two sides of the first lens 10.

Optionally, as shown in FIG. 2, the anti-reflection film may be provided on two sides of the second lens 20 respectively, allowing light to be incident into the human eye 01 as completely as possible to display an image.

In some examples of the present disclosure, the refractive index n of the first lens 10 and the second lens 20 is: 1.4<n<1.7; the Abbe number ν of the first lens 10 and the second lens 20 is: 20<ν<75.

For example, the refractive index n₁ of the first lens 10 is 1.54, and the Abbe number ν₁ is 56.3; the refractive index n₂ of the second lens 20 is 1.54, and the Abbe number ν₂ is 55.7.

Those skilled in the art may appropriately adjust the above optical parameters according to specific needs.

In some examples of the present disclosure, as shown in FIGS. 1 and 2, the first phase retarder 50 and the polarizing reflection element 60 may be sequentially provided between the second surface 12 and the third surface 21.

Here, the first phase retarder 50, for example, is a quarter-wave plate.

Cooperation of the first phase retarder 50 and the polarizing reflection element 60 may be used to analyze and transfer light.

For example, both the first phase retarder 50 and the polarizing reflection element 60 may be film structures and may be attached together.

For example, the first phase retarder 50 and the polarizing reflection element 60 are attached together and provided at a suitable position between the third surface 21 of the second lens 20 and the second surface 12 of the first lens 10; or, the first phase retarder 50 and the polarizing reflection element 60 are attached together and provided at a suitable position of the third surface 21 of the second lens 20.

Of course, both the first phase retarder 50 and the polarizing reflection element 60 may also be directly attached to the third surface 21 of the second lens 20.

Additionally, the first phase retarder 50 may be provided on one side of the third surface 21 of the second lens 20, while the polarizing reflection element 60 may be provided on one side of the fourth surface 22 of the second lens 20. The first phase retarder 50 and the polarizing reflection element 60 are spaced apart in the optical path structure.

Those skilled in the art may appropriately adjust the specific positions of the first phase retarder 50 and the polarizing reflection element 60 according to needs.

In some examples of the present disclosure, as shown in FIG. 2, the optical module further includes a polarizing element 70, which may be located between the polarizing reflection element 60 and the third surface 21.

Here, the polarizing element 70, for example, is a polarization film, which may be used to reduce stray light.

In some examples of the present disclosure, the polarizing element 70, the polarizing reflection element 60, and the first phase retarder 50 are stacked to form a laminated film structure and are attached to the third surface 21, with the polarizing element 70 connected to the third surface 21.

That is to say, in the embodiments of the present disclosure, the polarizing element 70, the polarizing reflection element 60, and the first phase retarder 50 may be sequentially stacked to form a composite film layer, and the composite film layer is then attached to the third surface 21 of the second lens 20.

Optionally, the anti-reflection film 30 may also be attached to the first phase retarder 50 of the composite film layer, as shown in FIG. 2. In this way, the polarizing element 70, the polarizing reflection element 60, the first phase retarder 50, and the anti-reflection film 30 may be sequentially stacked on the third surface 21.

At the same time, an anti-reflection film may also be provided on the fourth surface 22 of the second lens 20.

In some examples of the present disclosure, the reflectivity of the beam splitter 40 is 47% to 53%.

For example, the beam splitter 40 may be a transflective film.

In some examples of the present disclosure, as shown in FIGS. 1, 7, 12, 17, 22, 27, and 32, the optical module further includes a display 80, a light emergent surface of which is configured to emit circularly polarized light or linearly polarized light;
when the light emergent surface of the display 80 emits the linearly polarized light, a second phase retarder is provided between the light emergent surface of the display 80 and the first surface 11 of the first lens 10, and is used to convert the linearly polarized light into the circularly polarized light.

In the embodiments of the present disclosure, the optical module may include a display 80, and the light emergent surface of the display 80 is provided with a protective glass 81, and may emit light towards the first lens 10.

In the embodiments of the present disclosure, the second phase retarder may be provided on the light emergent surface of the display 80, or at a suitable position between the display 80 and the first lens 10, or at a suitable position close to the light emergent surface of the display 80.

In some examples of the present disclosure, the beam splitter 40 is attached to the first surface 11; or, the beam splitter 40 is provided between the light emergent surface of the display 80 and the first surface 11.

At the same time, an anti-reflection film may also be provided on the second surface 12 of the first lens 10.

According to the optical module provided by the embodiments of the present disclosure, the propagation process of light is as follows:

As shown in FIG. 1, the display 80 emits the circularly polarized light, the light is transmitted through the protective glass 81 of the light emergent surface of the display 80 and the first lens 10, is converted into the linearly polarized light (S-light) after passing through the first phase retarder 50 on the third surface 21 of the second lens 20, is reflected by the polarizing reflection element 60, is converted into the circularly polarized light after passing through the first phase retarder 50, is transmitted through the second surface 12 of the first lens 10, is reflected by the first surface 11 of the first lens 10, is transmitted through the second surface 12, is reflected by the first surface 11, is transmitted through the second surface 12, is converted into the linearly polarized light (P-light) after passing through the first phase retarder 50 on the third surface 21, is transmitted through the second lens 20, and finally is incident into the human eye 01.

The optical module provided by the embodiments of the present disclosure is specifically described below through three embodiments.

### First Embodiment

The optical module provided by the first embodiment of the present disclosure may be shown in FIGS. 1, 7, and 12, respectively. The optical module includes a first lens 10 and a second lens 20, the first lens 10 including a first surface 11 and a second surface 12, the second lens 20 including a third surface 21 and a fourth surface 22, the second surface 12 being provided adjacent to the third surface 21;
the optical module further includes a beam splitter 40, a first phase retarder 50, a polarizing reflection element 60, and a polarizing element 70; the beam splitter 40 is attached on the first surface 11, and the first phase retarder 50, the polarizing reflection element 60 and the polarizing element are stacked to form a laminated film structure, and are attached on the third surface 21 of the second lens 20, wherein the polarizing reflection element 60 is connected to the third surface 21;
here, the first lens 10 is configured to be translatable relative to the second lens 20, and satisfies: 2*(T1−T2)/D1=0.15, the maximum distance T1 over which the second surface 12 may be moved relative to the third surface 21 is 5.17, the minimum distance T2 over which the second surface 12 may be moved relative to the third surface 21 is 0.3 mm, the effective optical aperture D1 of the first lens 10 is 65 mm, and the difference between the hyperopia and myopia half-field angles is 5®. Through this constraint, by different diopter adjustments, it is possible to ensure that under a fixed eye-to-lens distance, there is no absence of the scene displayed by the display 80.

In the optical module provided by the present first embodiment, the optical parameters of the first lens 10 and the second lens 20 are specifically as shown in Table 1.

TABLE 1

| | Radius | Thickness | | | | | |
|---|---|---|---|---|---|---|---|
| Surface | (mm) | (mm) | Material | Conic | A2 | A4 | A6 |
| 22 | 102.4198 | 5.7732 | K26R | 2.4860 | 0.0000 | −1.803E−06 | 1.080E−08 |
| 21 | Infinity | 3.4981 | Air | 0.0000 | 0.0000 | 0.000E+00 | 0.000E+00 |
| 12 | 909.0000 | 8.2784 | APEL | 0.0000 | 0.0000 | 5.629E−06 | −1.885E−08 |
| 11 | −82.7338 | 3.7691 | Air | −0.0726 | 0.0000 | 1.465E−06 | −7.209E−10 |

| Surface | A8 | A10 | A12 | A14 | A16 |
|---|---|---|---|---|---|
| 22 | −2.211E−11 | 1.993E−14 | −7.151E−18 | 0.000E+00 | 0.000E+00 |
| 21 | 0.000E+00 | 0.000E+00 | 0.000E+00 | 0.000E+00 | 0.000E+00 |
| 12 | 9.193E−12 | −2.499E−16 | −1.592E−18 | 0.000E+00 | 0.000E+00 |
| 11 | −2.383E−12 | 3.969E−15 | −1.696E−18 | 0.000E+00 | 0.000E+00 |

As shown in FIG. 1, when the diopter is 0, the field angle of the imaging is 103.2°.

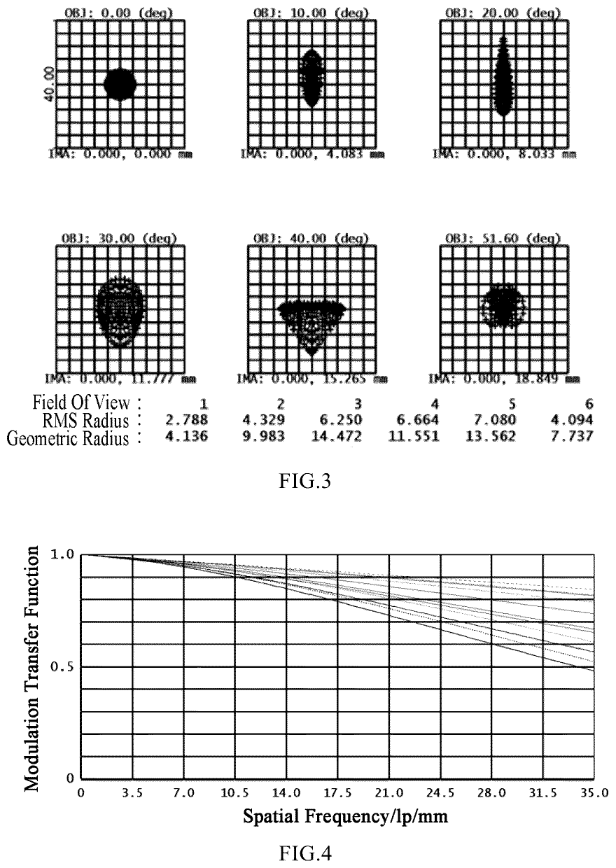

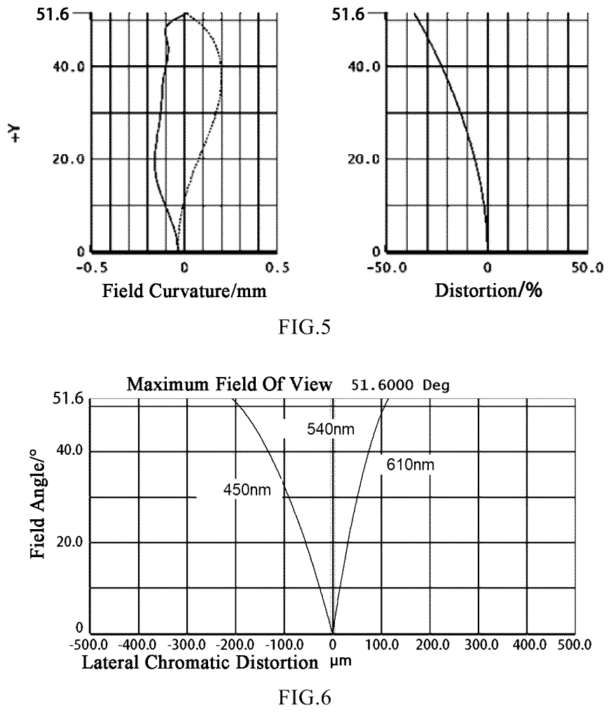

For the optical module shown in FIG. 1, as shown in FIGS. 3 to 6: FIG. 3 is a schematic diagram of a point array of the optical module; FIG. 4 is an MTF graph of the optical module; FIG. 5 is a field curvature distortion diagram of the optical module; FIG. 6 is a lateral chromatic distortion diagram of the optical module.

The point array refers to a dispersion pattern scattered in a certain range, which is formed when many rays of light emitted from one point, after passing through the optical module, are no longer concentrated at the same point of intersection with the image plane due to aberration, and may be used to evaluate the imaging quality of the optical module. As shown in FIG. 3, the RMS radii of all fields of view in point arrays do not differ much, and the maximum RMS radius is less than 8 mm.

The MTF graph is a modulation transfer function graph, which characterizes the imaging clarity of the optical module by the contrast of black and white line pairs. As shown in FIG. 4, the MTF at 15 lp/mm is greater than 0.8, causing clear imaging.

The field curvature distortion diagram reflects the difference in the position of the image plane that generates a clear image under different fields of view. As shown in FIG. 5, the maximum field curvature distortion occurs near the 0.7 field of view, with a maximum value of less than 0.4 mm. The distortion reflects the deformation at the time of imaging, and occurs at 1 field of view, with a maximum value of less than 40%.

The lateral chromatic distortion, also known as magnification chromatic aberration, primarily refers to the difference between the focal positions of blue and red light on the image plane when one main ray of a complex color on the object side becomes multiple rays on the image side due to dispersion in the refracting system. As shown in FIG. 6, the maximum chromatic dispersion occurs at 1 field of view, with the maximum chromatic aberration value of the optical module being less than 350 μm.

As shown in FIG. 7, in the case of hyperopia at 200 degrees, the field angle of imaging is 100°, and the first lens 10 is controlled to translate by 1.68 mm towards a side away from the second lens 20 (towards the right in FIG. 7). At this time, the maximum distance T1 from the second surface 12 to the third surface 21 is 5.17 mm.

Regarding the optical module shown in FIG. 7, as shown in FIGS. 8 to 11:

FIG. 8 is a schematic diagram of a point array of the optical module. As shown in FIG. 8, the RMS radii of all fields of view in point arrays do not differ much, and the maximum RMS radius is less than 8 mm.

FIG. 9 is an MTF graph of the optical module. As shown in FIG. 9, the MTF at 15 lp/mm is greater than 0.75, causing clear imaging.

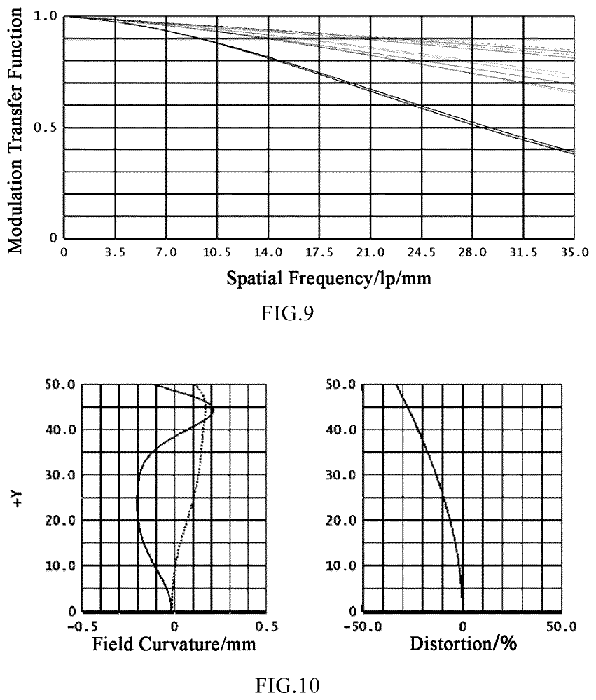

FIG. 10 is a field curvature distortion diagram of the optical module. As shown in FIG. 10, the maximum field curvature occurs near the 0.7 field of view, with a maximum value of less than 0.4 mm. The distortion occurs at 1 field of view, with a maximum value of less than 35%.

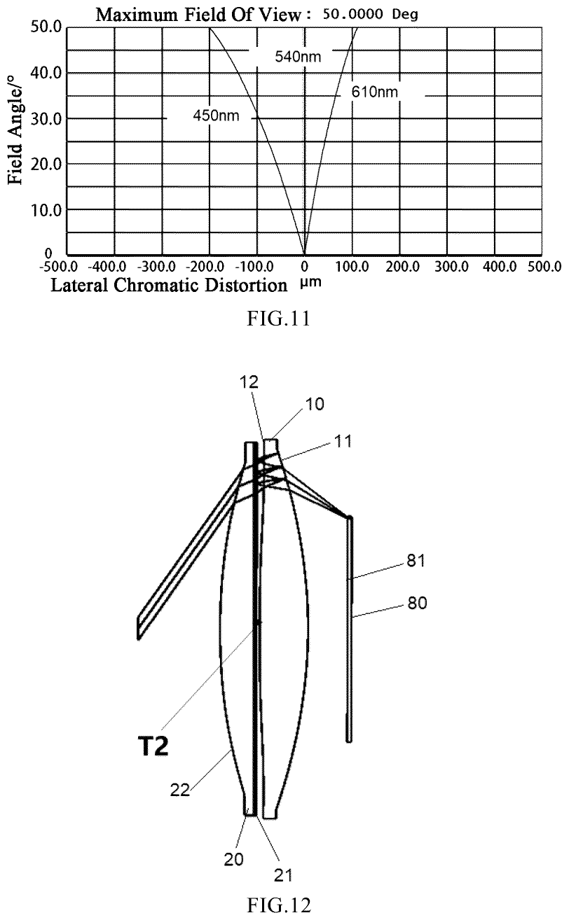

FIG. 11 is a lateral chromatic distortion diagram of the optical module. As shown in FIG. 11, the maximum chromatic dispersion occurs at 1 field of view, with the maximum chromatic aberration value of the optical module being less than 350 μm.

As shown in FIG. 12, in the case of myopia at 500 degrees, the field angle of imaging is 100°, and the first lens 10 is translated by 2.9 mm towards the proximity of the second lens 20 (towards the left in FIG. 12). At this time, the minimum distance T2 from the second surface 12 to the third surface 21 is 0.3 mm.

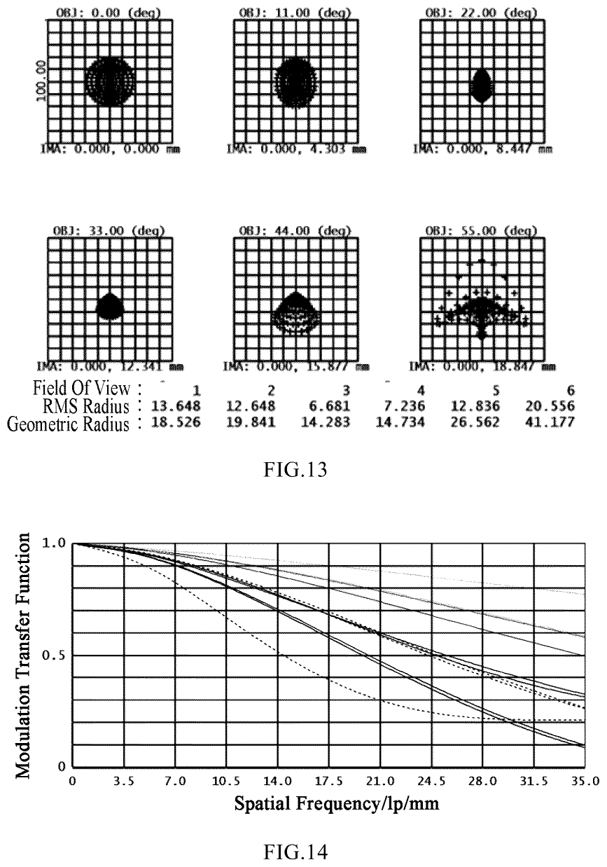

Regarding the optical module shown in FIG. 12, as shown in FIGS. 13 to 16:

FIG. 13 is a schematic diagram of a point array of the optical module. As shown in FIG. 13, the RMS radii of all fields of view in point arrays do not differ much, and the maximum RMS radius is less than 21 mm.

FIG. 14 is an MTF graph of the optical module. As shown in FIG. 14, the MTF at 15 lp/mm is greater than 0.45, causing clear imaging.

FIG. 15 is a field curvature distortion diagram of the optical module. As shown in FIG. 15, the maximum field curvature value is less than 0.75 mm. The maximum distortion value is less than 45%.

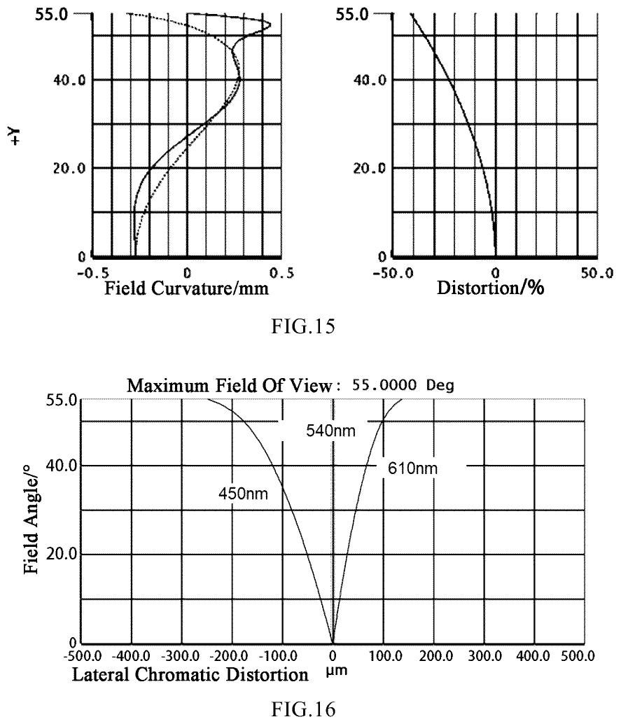

FIG. 16 is a lateral chromatic distortion diagram of the optical module. As shown in FIG. 16, the maximum chromatic dispersion occurs at 1 field of view, with the maximum chromatic aberration value of the optical module being less than 400 μm.

### Second Embodiment

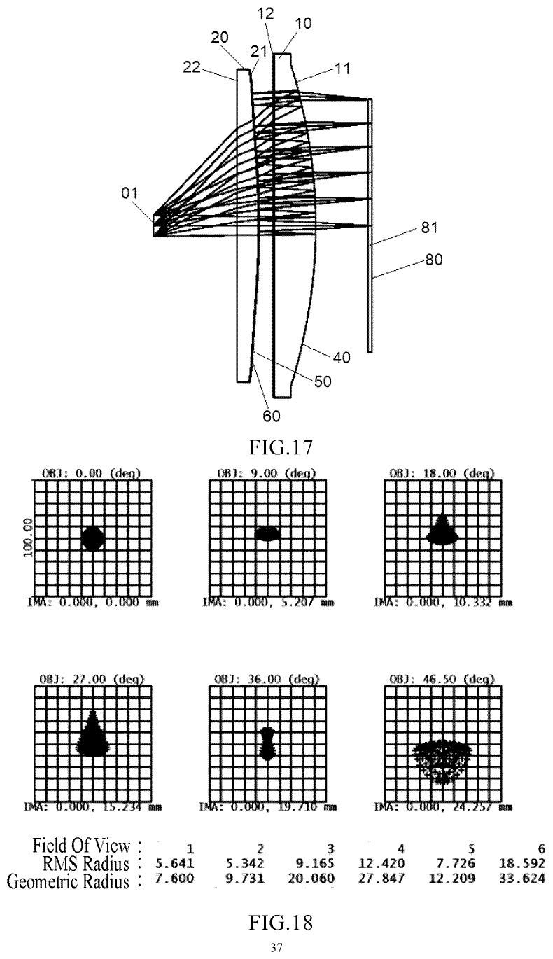

The optical module provided by the second embodiment of the present disclosure is shown in FIGS. 17 to 22. The optical module includes a first lens 10 and a second lens 20, the first lens 10 including a first surface 11 and a second surface 12, the second lens 20 including a third surface 21 and a fourth surface 22, the second surface 12 being provided adjacent to the third surface 21;
the optical module further includes a beam splitter 40, a first phase retarder 50, a polarizing reflection element 60, and a polarizing element 70; the beam splitter 40 is attached on the first surface 11, and the first phase retarder 50, the polarizing reflection element 60 and the polarizing element are stacked to form a laminated film structure, and are attached on the third surface 21 of the second lens 20, wherein the polarizing reflection element 60 is connected to the third surface 21;
here, the first lens 10 is configured to be translatable relative to the second lens 20, and satisfies: 2*(T1−T2)/D1=0.2, the maximum distance T1 over which the second surface 12 may be moved relative to the third surface 21 is 9.23, the minimum distance T2 over which the second surface 12 may be moved relative to the third surface 21 is 2.71 mm, the effective optical aperture D1 of the first lens 10 is 65 mm, and the difference between the hyperopia and myopia half-field angles is 1.5°. Through this constraint, by different diopter adjustments, it is possible to ensure that under a fixed eye-to-lens distance, there is no absence of the scene displayed by the display 80.

In the optical module provided by the present second embodiment, the optical parameters of the first lens 10 and the second lens 20 are specifically as shown in Table 2.

TABLE 2

| | Radius | Thickness | | | | | |
|---|---|---|---|---|---|---|---|
| Surface | (mm) | (mm) | Material | Conic | A2 | A4 | A6 |
| 22 | 1658.9185 | 4.1302 | K26R | 0.0000 | 0.0000 | −2.428E−06 | 4.311E−09 |
| 21 | −161.5851 | 2.7127 | Air | 0.0000 | 0.0000 | 1.092E−06 | 1.286E−09 |
| 12 | Infinity | 7.9984 | APEL | 0.0000 | 0.0000 | 0.000E+00 | 0.000E+00 |
| 11 | −97.2847 | 9.9105 | Air | 1.1376 | 0.0000 | 3.934E−07 | −3.010E−10 |

| Surface | A8 | A10 | A12 | A14 | A16 |
|---|---|---|---|---|---|
| 22 | 1.836E−12 | 0.000E+00 | 0.000E+00 | 0.000E+00 | 0.000E+00 |
| 21 | 3.961E−13 | −1.958E−15 | 0.000E+00 | 0.000E+00 | 0.000E+00 |
| 12 | 0.000E+00 | 0.000E+00 | 0.000E+00 | 0.000E+00 | 0.000E+00 |
| 11 | 1.890E−12 | −2.588E−15 | 1.032E−18 | 1.224E−23 | 0.000E+00 |

As shown in FIG. 17, in the case of hyperopia at 200 degrees, the field angle of imaging is 100°, and the maximum distance T1 from the second surface 12 to the third surface 21 is 9.23 mm.

Regarding the optical module shown in FIG. 17, as shown in FIGS. 18 to 21:

FIG. 18 is a schematic diagram of a point array of the optical module. As shown in FIG. 18, the RMS radii of all fields of view in point arrays do not differ much, and the maximum RMS radius is less than 18 mm.

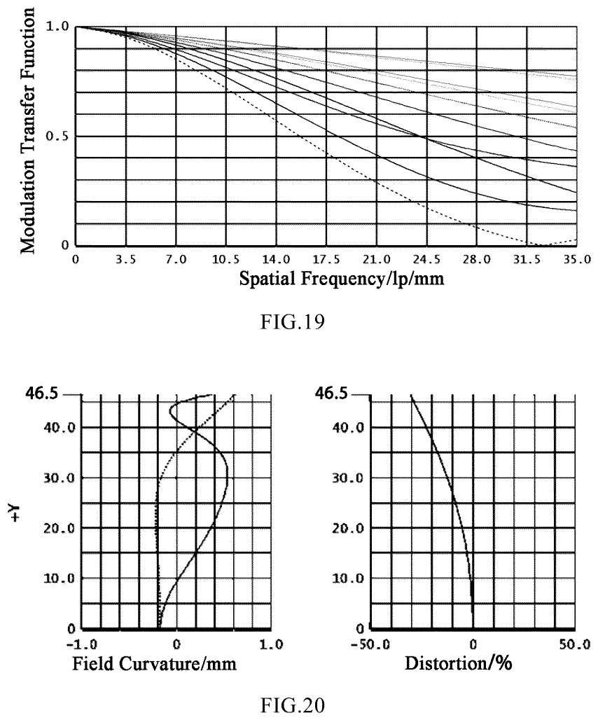

FIG. 19 is an MTF graph of the optical module. As shown in FIG. 19, the MTF at 15 lp/mm is greater than 0.5, causing clear imaging.

FIG. 20 is a field curvature distortion diagram of the optical module. As shown in FIG. 20, the maximum field curvature value is less than 0.4 mm. The maximum distortion value is less than 35%.

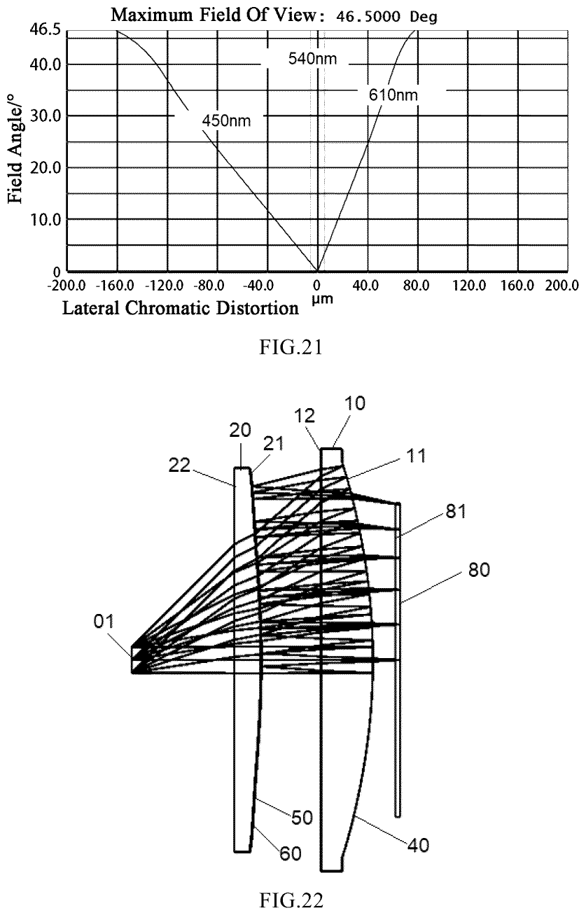

FIG. 21 is a lateral chromatic distortion diagram of the optical module. As shown in FIG. 21, the maximum chromatic dispersion occurs at 1 field of view, with the maximum chromatic aberration value of the optical module being less than 240 μm.

As shown in FIG. 22, in the case of myopia at 500 degrees, the field angle of imaging is 110°, and the minimum distance T2 from the second surface 12 to the third surface 21 is 2.71 mm.

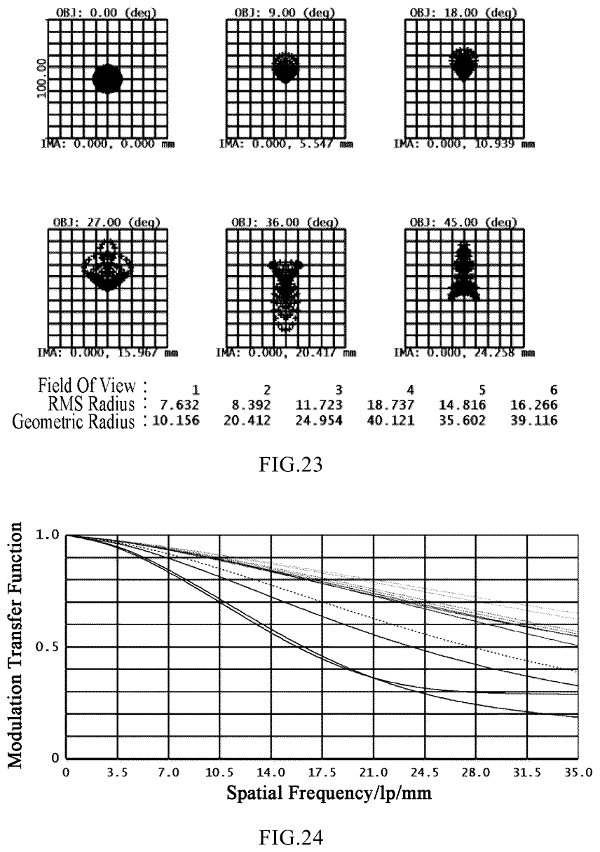

Regarding the optical module shown in FIG. 22, as shown in FIGS. 23 to 26:

FIG. 23 is a schematic diagram of a point array of the optical module. As shown in FIG. 23, the RMS radii of all fields of view in point arrays do not differ much, and the maximum RMS radius is less than 19 mm.

FIG. 24 is an MTF graph of the optical module. As shown in FIG. 24, the MTF at 15 lp/mm is greater than 0.45, causing clear imaging.

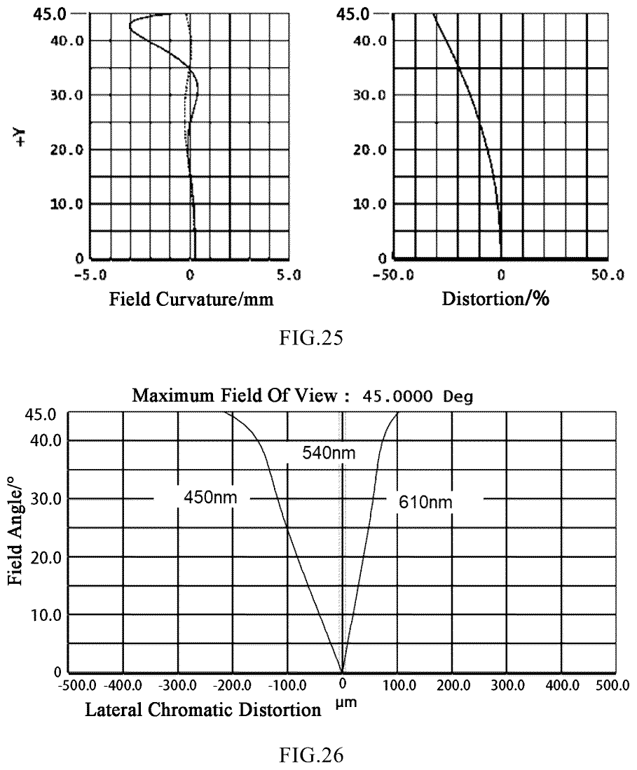

FIG. 25 is a field curvature distortion diagram of the optical module. As shown in FIG. 25, the maximum field curvature value is less than 0.35 mm. The maximum distortion value is less than 35%.

FIG. 26 is a lateral chromatic distortion diagram of the optical module. As shown in FIG. 26, the maximum chromatic dispersion occurs at 1 field of view, with the maximum chromatic aberration value of the optical module being less than 350 μm.

### Third Embodiment

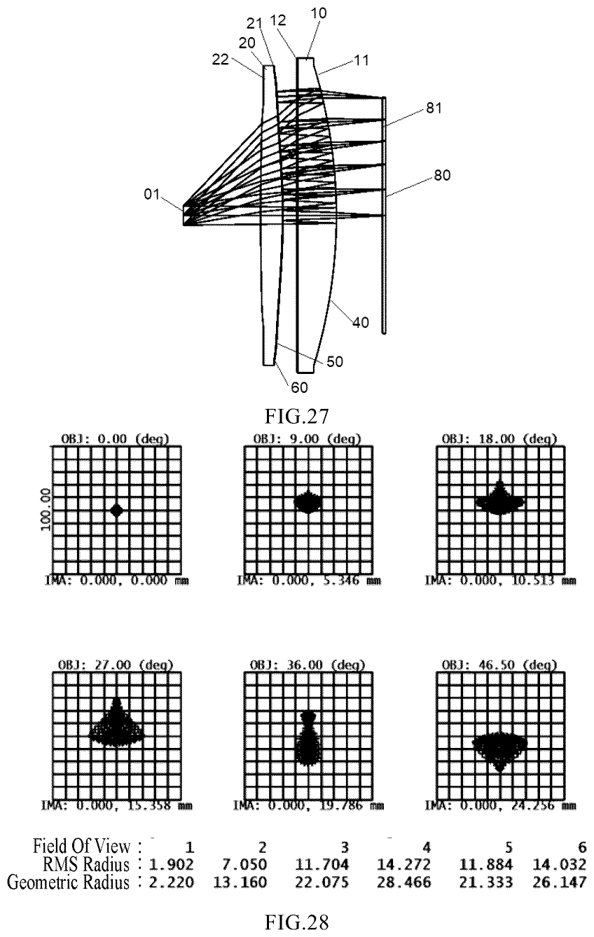

The optical module provided by the third embodiment of the present disclosure is shown in FIGS. 27 to 32. The optical module includes a first lens 10 and a second lens 20, the first lens 10 including a first surface 11 and a second surface 12, the second lens 20 including a third surface 21 and a fourth surface 22, the second surface 12 being provided adjacent to the third surface 21;
the optical module further includes a beam splitter 40, a first phase retarder 50, a polarizing reflection element 60, and a polarizing element 70; the beam splitter 40 is attached on the first surface 11, and the first phase retarder 50, the polarizing reflection element 60 and the polarizing element are stacked to form a laminated film structure, and are attached on the third surface 21 of the second lens 20, wherein the polarizing reflection element 60 is connected to the third surface 21;
here, the first lens 10 is configured to be translatable relative to the second lens 20, and satisfies: 2*(T1−T2)/D1=0.1, the maximum distance T1 over which the second surface 12 may be moved relative to the third surface 21 is 9.3 mm, the minimum distance T2 over which the second surface 12 may be moved relative to the third surface 21 is 2.88 mm, the effective optical aperture D1 of the first lens 10 is 65 mm, and the difference between the hyperopia and myopia half-field angles is 1.5°. Through this constraint, by different diopter adjustments, it is possible to ensure that under a fixed eye-to-lens distance, there is no absence of the scene displayed by the display 80.

In the optical module provided by the present third embodiment, the optical parameters of the first lens 10 and the second lens 20 are specifically as shown in Table 3.

TABLE 3

| | Radius | Thickness | | | | | |
|---|---|---|---|---|---|---|---|
| Surface | (mm) | (mm) | Material | Conic | A2 | A4 | A6 |
| 22 | 400.0000 | 4.5294 | K26R | 0.0000 | 0.0000 | −3.435E−06 | 6.054E−09 |
| 21 | −135.2952 | 7.0000 | Air | 0.0000 | 0.0000 | 5.155E−06 | −8.519E−09 |
| 12 | Infinity | 8.0000 | APEL | 0.0000 | 0.0000 | −2.899E−06 | 0.000E+00 |
| 11 | −100.0585 | 5.2922 | Air | 0.7184 | 0.0000 | 8.396E−07 | −2.263E−09 |

| Surface | A8 | A10 | A12 | A14 | A16 |
|---|---|---|---|---|---|
| 22 | −1.115E−14 | −1.592E−15 | 3.048E−18 | 0.000E+00 | 0.000E+00 |
| 21 | 1.181E−11 | −7.055E−15 | 0.000E+00 | 0.000E+00 | 0.000E+00 |
| 12 | 0.000E+00 | 0.000E+00 | 0.000E+00 | 0.000E+00 | 0.000E+00 |
| 11 | 4.790E−12 | −4.626E−15 | 1.559E−18 | 3.070E−23 | 0.000E+00 |

As shown in FIG. 27, in the case of hyperopia at 200 degrees, the field angle of imaging is 1000, and the maximum distance T1 from the second surface 12 to the third surface 21 is 9.3 mm.

Regarding the optical module shown in FIG. 27, as shown in FIGS. 28 to 31:

FIG. 28 is a schematic diagram of a point array of the optical module. As shown in FIG. 28, the RMS radii of all fields of view in point arrays do not differ much, and the maximum RMS radius is less than 15 mm.

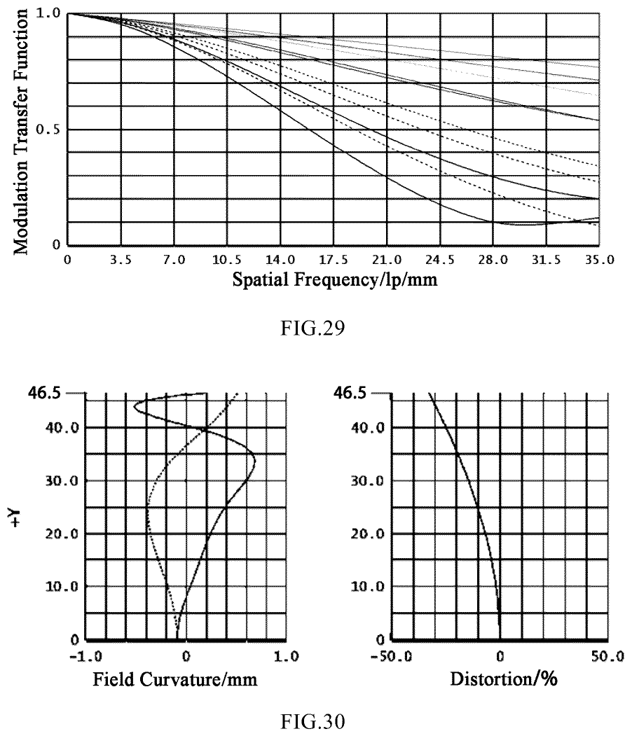

FIG. 29 is an MTF graph of the optical module. As shown in FIG. 29, the MTF at 15 lp/mm is greater than 0.5, causing clear imaging.

FIG. 30 is a field curvature distortion diagram of the optical module. As shown in FIG. 30, the maximum field curvature value is less than 1.2 mm. The maximum distortion value is less than 35%.

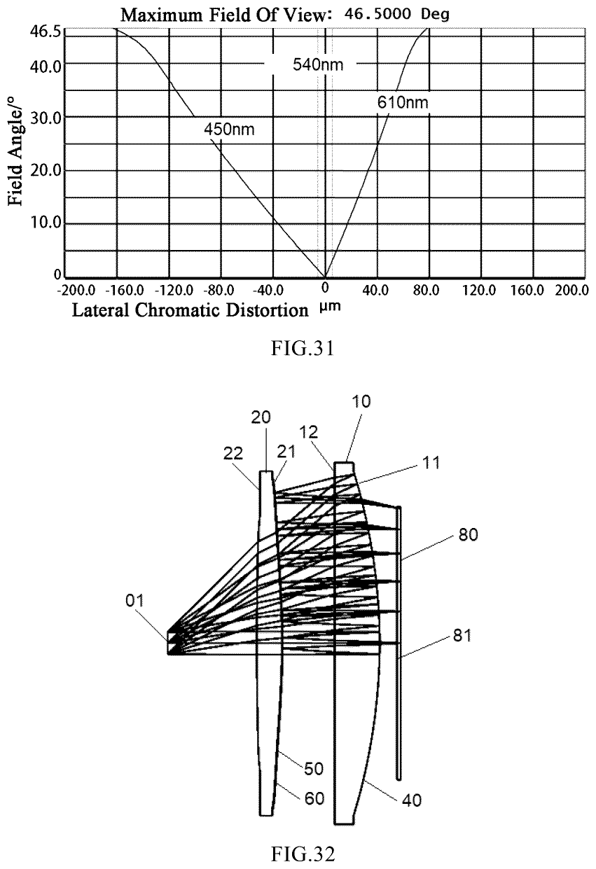

FIG. 31 is a lateral chromatic distortion diagram of the optical module. As shown in FIG. 31, the maximum chromatic dispersion occurs at 1 field of view, with the maximum chromatic aberration value of the optical module being less than 250 μm.

As shown in FIG. 32, in the case of myopia at 500 degrees, the field angle of imaging is 110°, and the minimum distance T2 from the second surface 12 to the third surface 21 is 2.88 mm.

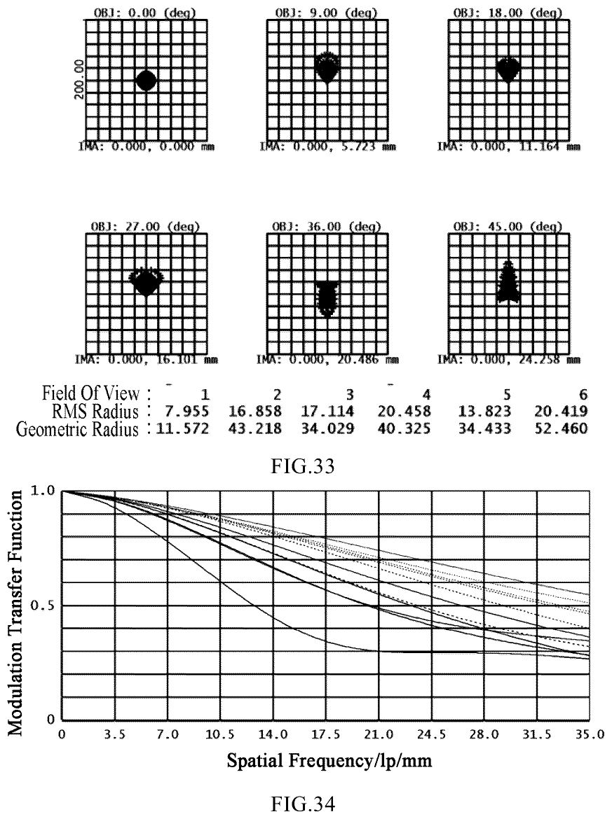

Regarding the optical module shown in FIG. 32, as shown in FIGS. 33 to 36:

FIG. 33 is a schematic diagram of a point array of the optical module. As shown in FIG. 33, the RMS radii of all fields of view in point arrays do not differ much, and the maximum RMS radius is less than 24 mm.

FIG. 34 is an MTF graph of the optical module. As shown in FIG. 34, the MTF at 15 lp/mm is greater than 0.4, causing clear imaging.

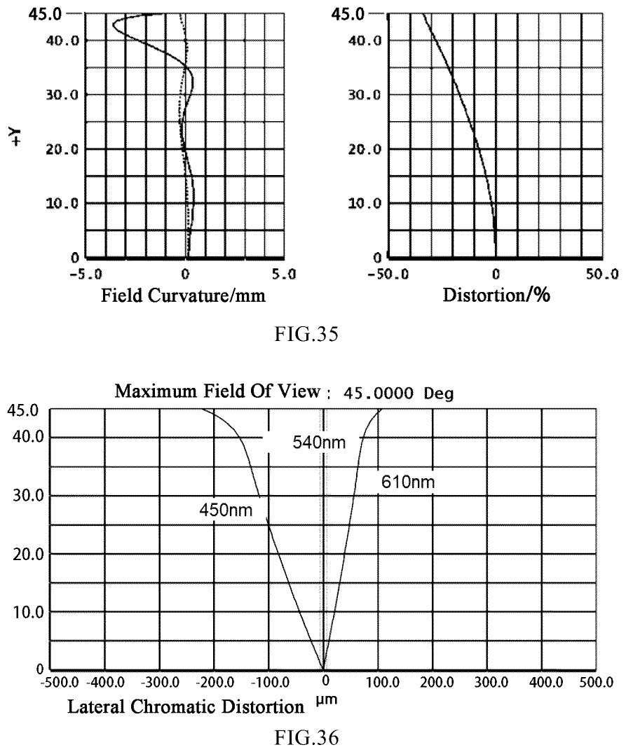

FIG. 35 is a field curvature distortion diagram of the optical module. As shown in FIG. 35, the maximum field curvature value is less than 5 mm. The maximum distortion value is less than 35%.

FIG. 36 is a lateral chromatic distortion diagram of the optical module. As shown in FIG. 36, the maximum chromatic dispersion occurs at 1 field of view, with the maximum chromatic aberration value of the optical module being less than 350 μm.

The optical module provided by the embodiments of the present disclosure, through the constraint of the difference in field angle under different diopters at the same eye-to-lens distance, it is possible to control the distortion value under different diopters, ensuring that the same distortion pre-correction is suitable for different diopter situations.

In the first embodiment, distortion in the case of hyperopia is −36%, distortion in the case of myopia is −40%, and the difference in distortion is 4%, which is less than 5%.

In the second embodiment, distortion in the case of hyperopia is −30.5%, distortion in the case of myopia is −31.5%, and the difference in distortion is 1.2%, which is less than 5%.

In the third embodiment, distortion in the case of hyperopia is −33.9%, distortion in the case of myopia is −32.7%, and the difference in distortion is 1.2%, which is less than 5%.

In the embodiments of the present disclosure, distortion in the case of myopia and distortion in the case of hyperopia may be achieved to be less than 5°.

According to another aspect of an embodiment of the present disclosure, there is also provided a head mounted display, which includes a housing, and the above optical module.

The head mounted display is, for example, a VR head mounted display, including VR glasses or a VR helmet, which is not specifically limited in the embodiments of the present disclosure.

The specific implementation of the head mounted display in the embodiments of the present disclosure may refer to embodiments of the above display module, and are not described herein.

The above embodiments focus on the differences between the various embodiments, and the different optimization features between the various embodiments, as long as they do not contradict each other, may be combined to form a better embodiment, which will not be repeated herein taking into account the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising a first lens and a second lens, the first lens comprising a first surface and a second surface, the second lens comprising a third surface and a fourth surface, the second surface being provided adjacent to the third surface;
the optical module further comprises a beam splitter, a first phase retarder, and a polarizing reflection element, the beam splitter is located on a side of the first surface, and the first phase retarder and the polarizing reflection element are located on a side of the second lens; and
the first lens is configured to translate relative to the second lens, which satisfies: 0.05<2*(T1−T2)/D1<0.3, wherein T1 is a maximum distance from the second surface to the third surface, T2 is a minimum distance from the second surface to the third surface, and D1 is an optical effective aperture of the first lens.

2. The optical module according to claim 1, wherein the first lens is configured for a translation in a direction away from or close to the second lens, which satisfies: 0.1<2*(T1−T2)/D1<0.2.

3. The optical module according to claim 1, wherein the first lens is configured for a translation relative to the second lens by 4 mm to 5.5 mm.

4. The optical module according to claim 1, wherein a distortion difference (a) between a hyperopia half-field angle of the optical module and a myopia half-field angle of the optical module satisfies: 0°<a<10°.

5. The optical module according to claim 1, wherein the first lens has a central thickness T₁: 3 mm<T₁<8 mm;
the second lens has a central thickness T₂: 3 mm<T₂<8 mm.

6. The optical module according to claim 1, wherein the first surface and the second surface are both aspherical;
the third surface is flat or aspherical, and the fourth surface is aspherical.

7. The optical module according to claim 1, wherein the first phase retarder and the polarizing reflection element are sequentially arranged between the second surface and the third surface.

8. The optical module according to claim 7, wherein the optical module further comprises a polarizing element, which is located between the polarizing reflection element and the third surface.

9. The optical module according to claim 8, wherein the polarizing element, the polarizing reflection element, and the first phase retarder are stacked to form a laminated film structure and attached to the third surface, and the polarizing element is connected to the third surface.

10. The optical module according to claim 1, wherein the beam splitter has a reflectivity of 47% to 53%.

11. The optical module according to claim 1, wherein the optical module further comprises a display and a light emergent surface thereof, configured to emit circularly polarized light or linearly polarized light;
when the light emergent surface is configured to emit the linearly polarized light, a second phase retarder is provided between the light emergent surface and the first surface of the first lens such that the linearly polarized light is converted into the circularly polarized light.

12. The optical module according to claim 10, wherein the beam splitter is attached to the first surface; or,
the beam splitter is located between the light emergent surface and the first surface.

13. A head-mounted display, comprising:
a housing; and
an optical module according to claim 1.
